(19) United States
(12) Patent Application Publication
(10) Pub. No.: US 2002/0043488 A1
(43) Pub. Date: Apr. 18, 2002

(54) Method and apparatus for the distribution of treatment liquids

(76) Inventors: Olivier Letessier, Paris (FR); Jean-Marc Girard, Tsukuba (JP); Akinobu Nasu, Tsukuba (JP)

Correspondence Address: E. Joseph Gess, BURNS, DOANE, SWECKER & MATHIS, L.L.P., P.O. Box 1404, Alexandria, VA, 22313-1404, US

(21) Appl. No.: 09/977,277

(22) Filed: Oct. 16, 2001

(30) Foreign Application Priority Data
Oct. 17, 2000 (JP) 2000-316930

(51) Int. Cl. B01D 17/12

(52) U.S. Cl. 210/90; 210/97; 210/138; 210/143; 210/198.1

(57) ABSTRACT

Provided are an apparatus and method for the distribution of treatment liquids. The apparatus and method enable the continuous monitoring of the level of a treatment liquid by an inexpensive mechanism that has little capacity to contaminate the treatment liquid. The apparatus for the distribution of treatment liquids contains a gastight distribution tank that is connected through a discharge line to designated facilities, and also contains a gastight gas container that is connected through a pressurization line to the distribution tank. A pressure regulator is provided in the pressurization line and the pressurization gas is thereby supplied from the gas container to the distribution tank at a constant and specified supply pressure. This supply of pressurization gas induces the pressure-transport of the treatment liquid from the distribution tank through the discharge line. The amount of change in the pressure of the gas container accompanying pressure-transport of the treatment liquid is detected by a pressure gauge, and a controller then calculates the amount of change in the treatment liquid level within the distribution tank.

### CROSS-REFERENCE TO RELATED APPLICATIONS

This application claims the benefit of priority to Japanese patent Application No. 2000-316930, filed Oct. 17, 2000, the entire contents of which are incorporated herein by reference.

### BACKGROUND OF THE INVENTION

1. Field of the Invention

This invention relates to an apparatus and method for the distribution of treatment liquids. More particularly, this invention relates to a technology for monitoring the level of a treatment liquid in a distribution tank during distribution of the treatment liquid. This invention is particularly useful for the distribution of treatment liquids in plants, installations, and facilities in which there are severe limitations on contamination of the treatment liquid by particles, for example, as in facilities for the fabrication and processing of semiconductor devices or electronic instruments or machinery.

2. Description of the Related Art

It is desirable during the distribution of a treatment liquid to a designated facility to monitor the level of the treatment liquid in its distribution tank in order to enable a stable feed of the treatment liquid. The mechanisms for monitoring treatment liquid levels generally comprise measurement of the position of a float floating in the treatment liquid and measurement of the pressure (weight) of the treatment liquid, but ultrasound probes and optical fibers are also used to monitor treatment liquid levels in facilities for the fabrication and processing of semiconductor devices or electronic instruments or machinery.

Float-based mechanisms run the risk of introducing particulate contaminants into the treatment liquid as a consequence of contact between the float and the inner surfaces of the distribution tank. In addition, float-based mechanisms and mechanisms based on measurement of treatment liquid pressure lack accuracy and are bulky. Mechanisms that employ an ultrasound probe or optical fiber require the incorporation of expensive elements into the treatment liquid distribution apparatus and raise its initial cost; it is also difficult with these mechanisms to continuously monitor the liquid level. Ultrasound probe and optical fiber mechanisms also increase the scale and complexity of the treatment liquid distribution apparatus itself.

### SUMMARY OF THE INVENTION

This invention was developed taking into consideration the problems delineated above for the prior art. The object of this invention is to provide an apparatus and method for the distribution of treatment liquids wherein the apparatus and method enable the continuous monitoring of the level of a treatment liquid by an inexpensive mechanism that has little capacity to contaminate the treatment liquid.

In accordance with a first aspect of the invention, an apparatus for the distribution of treatment liquids is provided. The apparatus comprises:

a gastight distribution tank that stores treatment liquid and that is connected via a discharge line to a designated facility,

a gastight gas container that is filled with a pressurization gas and that is connected via a pressurization line to the a distribution tank,

a valve that is provided in the pressurization line and that can selectively produce a state in which the treatment liquid is pressure-transported from the distribution tank through the discharge line to the designated facility, wherein the state is produced by utilizing the difference in pressure between the gas container and the distribution tank to supply pressurization gas from the gas container through the pressurization line to the distribution tank,

a pressure gauge that detects the pressure in the gas container, and a calculator that calculates the amount of change in the level of the treatment liquid in the distribution tank from the amount of change in the pressure gauge-detected pressure in the gas container accompanying pressure-transport of the treatment liquid.

According to a further aspect of the invention, the pressurization line is also provided with a pressure regulator for the purpose of reducing the pressure of the pressurization gas from the gas container to a constant and specified supply pressure prior to supplying the pressurization gas to the distribution tank.

According to a further aspect of the invention, the gas container has a sufficiently small volume as to make necessary a plural number of pressurization gas fill-and-discharge cycles in order to effect pressure-transport of the treatment liquid in the distribution tank, and in the calculator calculates the overall amount of change in the level of the treatment liquid by summing the amount of change in the treatment liquid level that is calculated for each cycle.

According to a further aspect of the invention, the distribution tank is configured in such a manner that the surface of the treatment liquid has a continuously constant surface area during the time interval of treatment liquid supply, and wherein the calculator calculates the amount of change in the level of the treatment liquid from equation (1):

Δh=(V/S)×(Tb/Ta)×((Pi−Pf)/Pb) (1)

wherein

Δh is the amount of change in the liquid level,

V is the volume of the gas container,

S is the surface area of the liquid surface,

Ta is the absolute temperature within the gas container,

Tb is the absolute temperature within the distribution tank,

Pi and Pf are, respectively, the preliminarily set initial pressure and preliminarily set final pressure of the gas container, and

Pb is the pressure of the gas container at the time of measurement.

According to a further aspect of the invention, the apparatus is additionally provided with a controller that, based on the amount of change in the treatment liquid level calculated by the calculator, automatically exercises the control necessary for exchange of the distribution tank or replenishment of treatment liquid in the distribution tank.

According to a further aspect of the invention, a method for the distribution of treatment liquids is provided. The method comprises:

storing a treatment liquid in a gastight distribution tank that is connected via a discharge line to a designated facility,

filling a pressurization gas into a gastight gas container that is connected via a pressurization line to the distribution tank,

pressure transporting the treatment liquid from the distribution tank through the discharge line to the designated facility, wherein the pressure-transport is effected by opening a valve that is provided in the pressurization line and supplying the pressurization gas from the gas container through the pressurization line to the distribution tank utilizing the pressure difference between the gas container and the distribution tank, and

calculating the amount of change in the treatment liquid level within the distribution tank by a calculator based on the amount of change in the pressure in the gas container accompanying the pressure-transport of the treatment liquid, wherein the pressure in the gas container is detected by a pressure gauge.

According to a further aspect of the invention, the method further comprises supplying the pressurization gas from the gas container to the distribution tank after the pressure of the pressurization gas has been reduced to a constant and specified supply pressure by action of a pressure regulator provided in the pressurization line.

According to a further aspect of the invention, a plural number of pressurization gas fill-and-discharge cycles are exercised at the gas container in order to pressure-transport the treatment liquid in the distribution tank, and the overall amount of change in the treatment liquid level is calculated by the calculator by summation of the amount of change in the treatment liquid level that is calculated for each of the cycles.

According to a further aspect of the invention, the distribution tank is configured in such a manner that the surface of the treatment liquid exhibits a continuously constant surface area during the time interval of treatment liquid feed, and the calculator calculates the amount of change in the treatment liquid level using equation (1):

Δh=(V/S)×(Tb/Ta)×((Pi−Pf)/Pb) (1)

wherein:

Δh is the amount of change in the liquid level,

V is the volume of the gas container,

S is the surface area of the liquid surface,

Ta is the absolute temperature within the gas container,

Tb is the absolute temperature within the distribution tank,

Pi and Pf are, respectively, the preliminarily set initial pressure and preliminarily set final pressure of the gas container, and

Pb is the pressure of the gas container at the time of measurement.

According to a further aspect of the invention, the method comprises automatically controlling exchange of the distribution tank or replenishment of the treatment liquid in the distribution tank, wherein the control is effected based on the amount of change in the treatment liquid level as calculated by the calculator.

The embodiments of this invention explore a variety of executions of this invention, and various embodiments of this invention can be derived by suitable combination of the plural number of disclosed constituent elements. For example, when an embodiment of the invention has been derived in which some constituent elements have been omitted from the overall set of constituent elements presented for the embodiment, these omitted elements can be suitably fulfilled by conventional well-known technologies in the actual working of the derived inventive embodiment.

The mechanism for monitoring treatment liquid levels employed by the inventive apparatus and method for the distribution of treatment liquids is less expensive than mechanisms that employ an ultrasound probe or optical fiber, while being more compact and more accurate than mechanisms that employ a float or that measure the pressure of the treatment liquid. The pressure gauge used by this invention will generally have a high sensitivity. However, pressure gauges also suffer from the problem of offset. This problem can be solved through use of a pressure difference.

One could also contemplate monitoring of the treatment liquid level through use of a gas flow meter to measure the amount of pressurization gas fed from the gas container to the distribution tank or a liquid flow meter to measure the amount of treatment liquid discharged from the distribution tank. However, flow meters have a tendency to be inaccurate when applied to measurement of the amount of flow of an intermittently fed fluid and are therefore not suitable for the apparatus and method for treatment liquid distribution to which this invention is directed.

### BRIEF DESCRIPTION OF THE DRAWINGS

FIG. 1 is a schematic diagram of a conduit layout in an apparatus for the distribution of treatment liquids in accordance with the invention;

FIG. 2 is a schematic diagram of the conduit layout in an apparatus for the distribution of treatment liquids in accordance with a further aspect of this invention; and

FIG. 3 is a diagram that illustrates the pressurization gas fill-and-discharge cycle at a gas container in a modified example of the embodiments illustrated in FIGS. 1 and 2.

### DETAILED DESCRIPTION OF PREFERRED EMBODIMENTS OF THE INVENTION

Embodiments of this invention are explained below with reference to the drawings. Constituent elements having approximately the same structure and function are assigned the same reference symbol, and their explanation will be repeated only when necessary.

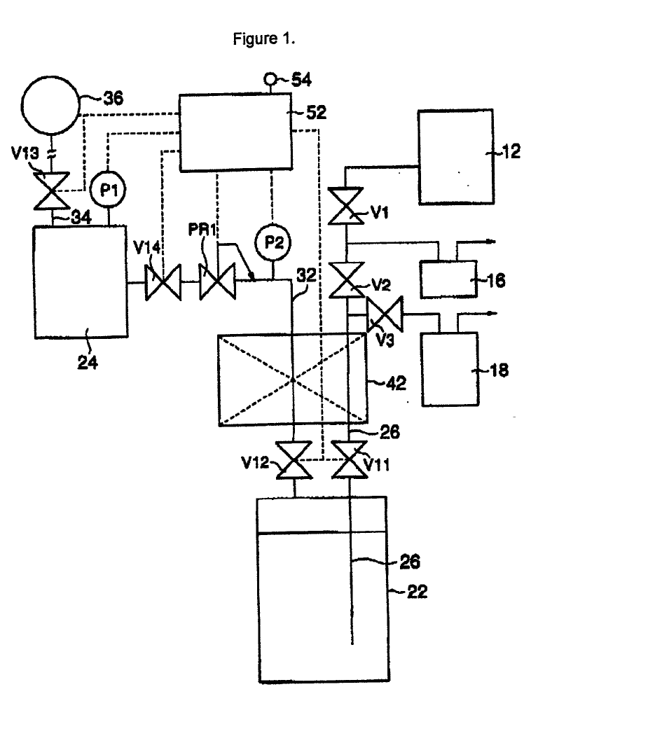

FIG. 1 contains a schematic illustration of the conduit layout in an embodiment of the inventive apparatus for the distribution of treatment liquids (abbreviated below simply as the distribution apparatus).

The subject distribution apparatus includes a gastight distribution tank 22 that contains treatment liquid. This distribution tank 22 is connected through a discharge line 26 to a designated facility external to the distribution apparatus, for example, a semiconductor processing system 12, a bubbler 16, and a secondary distribution container 18. This discharge line 26, whose purpose is to supply the treatment liquid to the designated facilities, is provided with valves V1, V2, and V3 for switching the line.

The subject distribution apparatus also contains a gastight gas container 24 that is filled with a pressurization gas (for example, helium (He)) residing at a pressure of about 0.5 MPa to 1.5 MPa. This gas container 24 is connected to the distribution tank 22 through the pressurization line 32 and is also connected to a large-volume gas tank 36 by a fill line 34.

The discharge line 26 and the pressurization line 32 are provided with, respectively, valve V11 and valve V12, in each case in the vicinity of the distribution tank 22. The pressurization line 32 and the fill line 34 are provided with, respectively, valve V14 and valve V13, in each case in the vicinity of the gas container 24. A pressure regulator PR1 is also provided in the pressurization line 32 between the valves V14 and V12. This pressure regulator PR1 functions to reduce the pressure of the pressurization gas in the gas container 24 to a constant and specified supply pressure Ps prior to feed of the pressurization gas to the distribution tank 22.

The pressurization gas is fed to the distribution tank 22 through the pressurization line 32 utilizing the pressure difference between the gas container 24 and the distribution tank 22. The pressurization gas pressurizes the interior of the distribution tank 22 to the supply pressure Ps established by the pressure regulator PR1, and this pressurization of the interior of the distribution tank 22 results in pressure-transport of the treatment liquid to the designated facility from the distribution tank 22 through the discharge line 26.

A manifold 42 is also provided in the discharge line 26 and the pressurization line 32. Provided in this manifold 42 are, for example, lines and valves for a purge gas and/or bypass lines and valves for suitable interconnection of the lines 26 and 32.

A pressure gauge P1 is attached to the gas container 24 and is also connected to a controller 52. Utilizing the pressure of the gas container 24 that is detected by the pressure gauge P1, the controller 52 exercises control in such a manner that the gas container 24 is used in a range—which resides above the supply pressure Ps established by the pressure regulator PR1—between a preliminarily set initial pressure Pi and a preliminarily set final pressure Pf. More specifically, the controller 52 controls, inter alia, the processes of opening and closing the valves V13 and V14 in the vicinity of the gas container 24 and the process of filling pressurization gas from the gas tank 36 through the fill line 34 into the gas container 24.

The controller 52 also has the ability, in a mode discussed below, to function as a calculator that can calculate the amount of change in the treatment liquid level in the distribution tank 22 from the amount of change in the pressure of the gas container 24 (pressure as detected by the pressure gauge P1). Based on the calculated amount of change in the treatment liquid level, the controller 52 can also verify that the treatment liquid level within the distribution tank 22 has reached a certain preliminarily set lower limit and can exercise the control necessary to exchange the distribution tank 22 or replenish the treatment liquid. Expressed in more specific terms, the controller 52 has the ability to control, inter alia, the opening and closing operations of the valves V11 and V12 in the vicinity of the distribution tank 22 and the ON/OFF status of the alarm 54 that alerts the operator of the necessity for exchanging the distribution tank 22 or replenishing the treatment liquid.

A pressure gauge P2 is provided in the pressurization line 32 between the pressure regulator PR1 and the valve V12 and is also connected to the controller 52. Based on the pressure in the pressurization line 32 as detected by the pressure gauge P2, the controller 52 effects control of the pressure regulator PR1 so as to supply the pressurization gas to the distribution tank 22 at a constant and specified supply pressure Ps.

An embodiment of the inventive method for the distribution of treatment liquids that employs the apparatus of FIG. 1 is explained hereinbelow.

First, the supply pressure Ps, for example, 0.3 MPa, of the pressurization gas afforded by the pressure regulator PR1 is set based on the flow rate and pressure required by the designated facilities 12, 16, and 18. The initial pressure Pi of the gas container 24 and the final pressure Pf of the gas container 24 are also set; these pressures should be set in a range higher than the supply pressure Ps, for example, 1.5 MPa for the former and 0.5 MPa for the latter. The lower limit for the treatment liquid level is set with reference to the initial level (predetermined value) of the treatment liquid in the distribution tank 22. These various predetermined or preset values are input into the controller 52.

The treatment liquid is stored in the distribution tank 22 by the manufacturer or user with the level of the treatment liquid satisfying the predetermined initial value. The thusly prepared distribution tank 22 is then connected to the lines 26 and 32 and the following processes are subsequently executed under control by the controller 52.

With the valve V14 closed and the valve V13 open, pressurization gas is first filled into the gas container 24 through the fill line 34 from the gas tank 36. Filling of the pressurization gas is halted when the pressure in the gas container 24 reaches the preset initial pressure Pi, at which point the valve 13 is closed.

The valve 14 is then opened and—under the effect of the pressure difference between the gas container 24 and the distribution tank 22—pressurization gas is supplied from the gas container 24 through the pressurization line 32 into the distribution tank 22. During this sequence, the pressure of the pressurization gas from the gas container 24 is reduced by the pressure regulator PR1 to a constant and specified supply pressure Ps and the pressurization gas is thereafter supplied to the distribution tank 22. The distribution tank 22 is thereby pressurized to a constant and specified pressure and the treatment liquid therein is continuously pressure-transported at a constant and specified pressure and flow rate from the distribution tank 22 through the discharge line 26 to the designated facilities 12, 16, and 18.

The pressure in the gas container 24 is detected by the pressure gauge P1 during pressure-transport of the treatment liquid, and the controller 52 calculates the amount of change in the treatment liquid level within the distribution tank 22 from the amount of change in the pressure in the gas container 24 as detected by the pressure gauge P1. Equation (1), for example, can be used by the controller 52 in its calculator capacity to calculate the amount of change in the treatment liquid level.

Δh=(V/S)×(Tb/Ta)×((Pi−Pf)/Pb) (1)

wherein:

Δh is the amount of change in the treatment liquid level,

V is the volume of the gas container 24,

S is the surface area of the liquid surface,

Ta is the absolute temperature within the gas container 24,

Tb is the absolute temperature within the distribution tank 22,

Pi and Pf are, respectively, the preliminarily set initial pressure and preliminarily set final pressure of the gas container 24, and

Pb is the pressure of the gas container 24 at the time of measurement.

Equation (1) is derived based on the assumption that the distribution tank 22 has a typical or conventional shape, or, in more specific terms, is designed to have an internal structure such that the treatment liquid has a continuously constant surface area throughout the range between the initial value of the treatment liquid surface level and the lower limit of the treatment liquid surface level (period of treatment liquid supply by the distribution tank 22). However, even when the structure of the distribution tank 22 does not satisfy this condition, equation (1) can still be used through the insertion therein of a suitable correction term.

When the distribution tank 22 and the gas container 24 are situated in a common environment, the value of Tb/Ta becomes approximately equal to 1 and the (Tb/Ta) term in equation (1) can then be neglected from a practical standpoint. However, when the distribution tank 22 and the gas container 24 are situated in entirely different environments, the temperatures Tb and Ta must then be measured and the resulting values used in equation (1).

Proceeding as described above, the controller 52 can continuously monitor the treatment liquid level within the distribution tank 22 using the results calculated based on the pressure in the gas container 24. When the calculated treatment liquid level falls to or below the preset lower limit, the controller 52 also effects the control actions necessary for exchange of the distribution tank 22 or replenishment of the treatment liquid, for example, as necessary the controller 52 can close the valves V11 and V12 and activate the alarm 54.

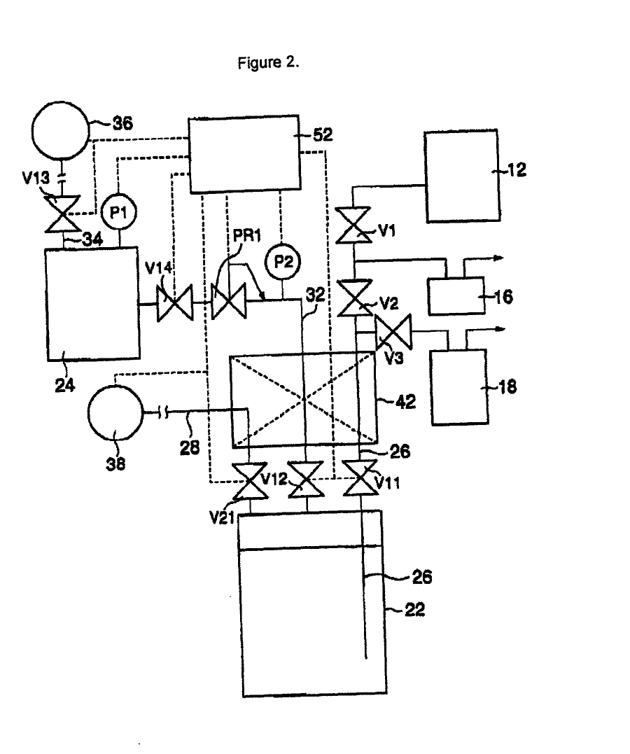

FIG. 2 contains a schematic illustration of the conduit layout in another embodiment of the inventive distribution apparatus.

The distribution apparatus in FIG. 2 comprises the apparatus of FIG. 1 with the addition thereto of a replenishment line 28 that connects the distribution tank 22 to a large-volume treatment liquid tank 38. A valve V21 is provided in the replenishment line 28 in the vicinity of the distribution tank 22. Elements such as a bypass line and valving therefor and/or a purge gas line and valving therefor are provided in the replenishment line 28 in the manifold 42.

In this case, the controller 52 is additionally provided with the capacity to execute a control sequence that enables the distribution tank 22 to be used—again based on the calculated amount of change in the treatment liquid level within the distribution tank 22—in a range defined by a preset upper limit and lower limit for the treatment liquid level. In other words, the controller 52 can exercise control of an operation in which the treatment liquid in the distribution tank 22 is replenished from the treatment liquid tank 38 through the replenishment line 28.

An embodiment of the inventive method for the distribution of treatment liquids that employs the apparatus of FIG. 2 is explained hereinbelow.

In this method, upper and lower limits for the treatment liquid level in the distribution tank 22 are also set when the supply pressure Ps for the pressurization gas and the initial pressure Pi and final pressure Pf for the gas container 24 are set. These set values are then input to the controller 52 and the following sequences are thereafter executed under control by the controller 52.

Treatment liquid is first supplied from the treatment liquid tank 38 through the replenishment line 28 to the distribution tank 22. Supply of the treatment liquid is halted when the treatment liquid level within the distribution tank 22 reaches the preset upper limit.

Using the same method as the treatment liquid distribution method described above in connection with the apparatus illustrated in FIG. 1, pressurization gas is filled into the gas container 24 and treatment liquid is thereafter pressure-transported from the distribution tank 22 by discharge of the pressurization gas from the gas container 24. The treatment liquid level within the distribution tank 22 is continuously monitored by calculation of the amount of change in the treatment liquid level within the distribution tank 22 from the amount of change in the pressure in the gas container 24. When the calculated treatment liquid level reaches or falls below the preset lower limit, the controller 52 halts the introduction of the pressurization gas into the distribution tank 22 and thereby also halts the supply of the treatment liquid. The distribution tank 22 is then replenished with treatment liquid through the replenishment line 28 from the treatment liquid tank 38 until the treatment liquid level reaches the preset upper limit.

Since in the distribution apparatuses illustrated in FIGS. 1 and 2 the pressurization gas is filled in a compressed state into the gas container 24, the volume of the gas container 24 can be substantially smaller than the volume of the distribution tank 22. However, when the volume of the gas container 24 is so small that pressure-transport of the treatment liquid cannot be carried out from the distribution tank 22 over its entire treatment liquid supply period using a single fill of the pressurization gas, it will be necessary to refill the gas container 24 with pressurization gas during the treatment liquid supply period. In such a case the following process is carried out under control by the controller 52.

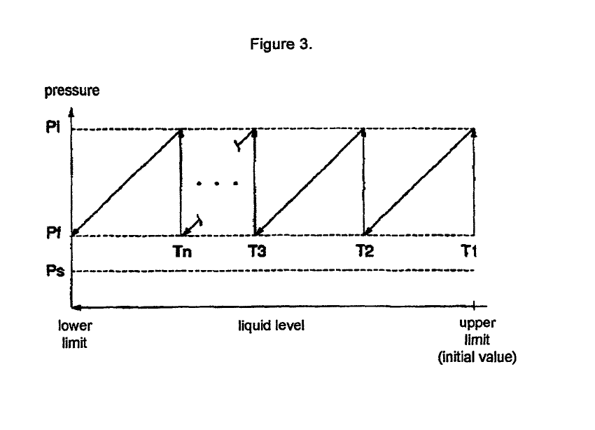

FIG. 3 illustrates the pressurization gas fill-and-discharge cycle at the gas container 24 in an example of the modification described in the preceding paragraph. The x-axis in FIG. 3 plots the level of the treatment liquid within the distribution tank 22, while the y-axis plots the pressure within the gas container 24.

After the pressurization gas has been filled into the gas container 24 (first fill at time T1), the pressure within the gas container 24 declines to the preset final pressure Pf—which is still higher than the pressurization gas supply pressure Ps established by the pressure regulator PR1—due to pressure-transport of the treatment liquid in the distribution tank 22. At time T2 the valve 14 is closed and the valve V13 is opened and the gas container 24 is refilled with pressurization gas (second fill) through fill line 34 from the gas tank 36.

When the pressure within the gas container 24 reaches the preset initial pressure Pi, the valve V13 is closed to complete the pressurization gas refill. At the same time, the valve V14 is opened and pressure-transport of the treatment liquid within the distribution tank 22 is resumed due to discharge of pressurization gas from the gas container 24. This process is repeated and the gas container 24 is again filled with pressurization gas (third fill) when at time T3 the pressure in the gas container 24 reaches the final pressure Pf. This fill and discharge of pressurization gas can be repeated a total of n times until the treatment liquid level reaches or falls below its preset lower limit.

Treatment liquid flow rates are typically low and refilling of the gas container 24 in this modification example will take only a few seconds since the gas container 24 in this case has a small volume. As a consequence, pressure-transport of the treatment liquid from the distribution tank 22 will continue even with the valve V14 in closed position during refill of the gas container 24. During this period the pressure detected by the pressure gauge P2 essentially will not decline.

In accordance with the embodiments already described above, the controller 52 will calculate the amount of change in the treatment liquid level within the distribution tank 22 for each cycle of fill and discharge of the pressurization gas from the gas container 24 into the distribution tank 22. The overall amount of change in the treatment liquid level is then calculated by summing the individual amounts of change using equation (2).

Δhₜ=Δh₁+Δh₂+Δh₃+. . . +Δhn (2)

wherein:

Δhₜ is the overall amount of change in the treatment liquid level

Δhᵢ (i=positive integer) is the amount of change in the treatment liquid level in the particular individual fill-and-discharge cycle

The controller 52 can again exercise continuous monitoring of the treatment liquid level within the distribution tank 22, in this case using the results calculated as described above based on the pressure in the gas container 24. When the calculated treatment liquid level reaches or falls below the preset lower limit, the controller 52 will carry out exchange of the distribution tank 22 (apparatus illustrated in FIG. 1) or replenishment of treatment liquid into the distribution tank 22 (apparatus illustrated in FIG. 2).

The pressurization gas used for pressure-transport of the treatment liquid in the embodiments described above with reference to FIGS. 1, 2, and 3 can be any gas that is inert with regard to the treatment liquid, but will preferably be an inert gas such He, Ar (argon), N₂ (nitrogen), and the like.

While various modifications and alterations within the technical sphere of the concept of this invention can be devised by the individual skilled in the art, it should be understood that these modifications and alterations also fall within the scope of this invention.

### Advantageous Effects of the Invention

As has been described hereinabove, this invention provides an apparatus and method for the distribution of treatment liquids wherein the apparatus and method enable the level of a treatment liquid to be continuously monitored using an inexpensive mechanism that has little capacity to contaminate the treatment liquid.

What is claimed is:

1. Apparatus for the distribution of treatment liquids, comprising:
a gastight distribution tank that stores treatment liquid and that is connected via a discharge line to a designated facility,
a gastight gas container that is filled with a pressurization gas and that is connected via a pressurization line to the distribution tank,
a valve that is provided in the pressurization line and that can selectively produce a state in which the treatment liquid is pressure-transported from the distribution tank through the discharge line to the designated facility, wherein the state is produced by utilizing the difference in pressure between the gas container and the distribution tank to supply pressurization gas from the gas container through the pressurization line to the distribution tank,
a pressure gauge that detects the pressure in the gas container, and
a calculator that calculates the amount of change in the level of the treatment liquid in the distribution tank from the amount of change in the pressure gauge-detected pressure in the gas container accompanying pressure-transport of the treatment liquid.

2. The apparatus according to claim 1, wherein the pressurization line is also provided with a pressure regulator for the purpose of reducing the pressure of the pressurization gas from the gas container to a constant and specified supply pressure prior to supplying the pressurization gas to the distribution tank.

3. The apparatus according to claim 1, wherein the gas container has a sufficiently small volume as to make necessary a plural number of pressurization gas fill-and-discharge cycles in order to effect pressure-transport of the treatment liquid in the distribution tank, and wherein the calculator calculates the overall amount of change in the level of the treatment liquid by summing the amount of change in the treatment liquid level that is calculated for each cycle.

4. The apparatus according to claim 1, wherein the distribution tank is configured in such a manner that the surface of the treatment liquid has a continuously constant surface area during the time interval of treatment liquid supply, and wherein the calculator calculates the amount of change in the level of the treatment liquid from equation (1):
Δh=(V/S)×(Tb/Ta)×((Pi−Pf)/Pb) (1)
wherein:
Δh is the amount of change in the liquid level,
V is the volume of the gas container,
S is the surface area of the liquid surface,
Ta is the absolute temperature within the gas container,
Tb is the absolute temperature within the distribution tank,
Pi and Pf are, respectively, the preliminarily set initial pressure and preliminarily set final pressure of the gas container, and
Pb is the pressure of the gas container at the time of measurement.

5. The apparatus according to claim 1, wherein the apparatus is additionally provided with a controller that, based on the amount of change in the treatment liquid level calculated by the calculator, automatically exercises the control necessary for exchange of the distribution tank or replenishment of treatment liquid in the distribution tank.

6. Method for the distribution of treatment liquids, comprising:
storing a treatment liquid in a gastight distribution tank that is connected via a discharge line to a designated facility,
filling a pressurization gas into a gastight gas container that is connected via a pressurization line to the distribution tank,
pressure transporting the treatment liquid from the distribution tank through the discharge line to the designated facility, wherein the pressure-transport is effected by opening a valve that is provided in the pressurization line and supplying the pressurization gas from the gas container through the pressurization line to the distribution tank utilizing the pressure difference between the gas container and the distribution tank, and
calculating the amount of change in the treatment liquid level within the distribution tank by a calculator based on the amount of change in the pressure in the gas container accompanying the pressure-transport of the treatment liquid, wherein the pressure in the gas container is detected by a pressure gauge.

7. The method according to claim 6, further comprising supplying the pressurization gas from the gas container to the distribution tank after the pressure of the pressurization gas has been reduced to a constant and specified supply pressure by action of a pressure regulator provided in the pressurization line.

8. The method according to claim 6, wherein a plural number of pressurization gas fill-and-discharge cycles are exercised at the gas container in order to pressure-transport the treatment liquid in the distribution tank, and wherein the overall amount of change in the treatment liquid level is calculated by the calculator by summation of the amount of change in the treatment liquid level that is calculated for each of the cycles.

9. The method according to claim 6, wherein the distribution tank is configured in such a manner that the surface of the treatment liquid exhibits a continuously constant surface area during the time interval of treatment liquid feed, and the calculator calculates the amount of change in the treatment liquid level using equation (1):
Δh=(V/S)×(Tb/Ta)×((Pi−Pf)/Pb) (1)
wherein:
Δh is the amount of change in the liquid level,
V is the volume of the gas container,
S is the surface area of the liquid surface,
Ta is the absolute temperature within the gas container,
Tb is the absolute temperature within the distribution tank,
Pi and Pf are, respectively, the preliminarily set initial pressure and preliminarily set final pressure of the gas container, and
Pb is the pressure of the gas container at the time of measurement.

10. The method according to claim 6, further comprising automatically controlling exchange of the distribution tank or replenishment of the treatment liquid in the distribution tank, wherein the control is effected based on the amount of change in the treatment liquid level as calculated by the calculator.
